(19) United States
(12) Patent Application Publication
(10) Pub. No.: US 2017/0004134 A1
(43) Pub. Date: Jan. 5, 2017

(54) ASYNCHRONOUS SEARCH QUERY

(71) Applicant: Microsoft Technology Licensing, LLC, Redmond, WA (US)

(72) Inventors: Joseph W. Pepper, JR., Kirkland, WA (US); Gabe Young, Tauranga (NZ)

(21) Appl. No.: 14/791,344

(22) Filed: Jul. 3, 2015

(51) Int. Cl. G06F 17/30

(52) U.S. Cl. CPC G06F 17/3053; G06F 17/30554; G06F 17/30867

(57) ABSTRACT

Implementations described herein request recommendations from recipients of a recommendation request. A requester of a recommendation defines objective criteria to limit search results relating to the recommendation. These objective criteria can be uniquely specified in a recommendation request with a location or a link to a location in which recipients of the recommendation request can enter a search query to search for entities to recommend. The requester shares the recommendation request with a set of recipients via one or more communication channels (e.g., over a network). The recipients each then conduct a search for an entity to recommend using an unstructured query. The search results are ranked based on the objective criteria entered by the requester and their relevance to the entered query terms. Each recipient can recommend one or more of the search results that appear in response to the recommendation request.

### BACKGROUND

With the proliferation of data on the World Wide Web, computer users often become inundated with information from various sources. Much of the information might seem suspicious or untrustworthy to such a user because the source of the information and the trustworthiness of the source are unknown.

Computer users these days often have many on-line contacts and many ways of communicating with these contacts. Social networks are popular as are various other ways of communication such as email, texting, blogging, and so forth. People tend to have more trust in their on-line contacts or contacts that are friends of their on-line contacts.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In general, the recommendation request implementations described herein request recommendations from a user's contacts or other people. In some implementations this is done by using a two part asynchronous search. In the first part of the search, objective criteria are defined by a first user to limit the types of recommendations the user is looking for. In the second part of the search, a second user provides a recommendation by conducting a search of an entity database for entities to recommend using an unstructured query. The search results are then ranked by their relevance to the unstructured query submitted by the second user and the objective criteria entered by the first user.

In one implementation, objective criteria are defined. For example, a first user/requester defines objective criteria for a recommendation he desires by selecting objective criteria from pre-defined categories and/or sub-categories on his or her computing device. A recommendation request based on the objective criteria is formatted. Such a recommendation request can have a link to a location (e.g., a URL to a website) that provides a place to enter a search query or the recommendation request can itself have a place to enter a search query to search an entity database for an entity that fulfills the request. The first user that desires the recommendation (e.g., the requester) indicates the desire to share the recommendation request and the first user's computing device then shares the recommendation request with one or more additional users (e.g., recipients) over a network. One or more recipients can then enter a query of search terms on their computing devices and receive search results of possible entities to recommend in response. These search results (e.g., entities) are ranked based on their relevance to the terms of the query, but also based on the objective criteria associated with the recommendation request. For example, this can be done by ranking the search results based on the terms of the search query and then re-ranking these ranked search results based on the objective criteria. Alternately, the search terms of the query can be combined with the objective criteria in order to search for entities to recommend and determine the ranking. The recipient then selects one or more of the ranked search results and provides them to the requester as a recommendation.

### DESCRIPTION OF THE DRAWINGS

The specific features, aspects, and advantages of the disclosure will become better understood with regard to the following description, appended claims, and accompanying drawings where:

FIG. 1 is a schematic that depicts an exemplary computing environment in which the recommendation request implementations described herein may be practiced.

FIG. 2 is a functional block diagram of an exemplary process for requesting recommendations according to one recommendation request implementation described herein.

FIG. 3 is a functional block diagram of another exemplary process for requesting recommendations according to another recommendation request implementation described herein.

FIG. 4 is functional block diagram of yet another exemplary process for requesting recommendations according to another recommendation request implementation described herein.

FIG. 5 is functional block diagram of yet another exemplary process for requesting recommendations according to another recommendation request implementation often described herein.

FIG. 6 is functional block diagram of yet another exemplary process for requesting recommendations according to another recommendation request implementation described herein.

FIG. 7 is functional block diagram of yet another exemplary process for requesting recommendations according to another recommendation request implementation described herein.

FIG. 8 is an exemplary block diagram of a system for requesting recommendations according to various recommendation request implementations described herein.

FIG. 9 is an exemplary user interface depicting a recommendation request received by a recipient.

FIG. 10 is an exemplary user interface depicting how a recommendation is displayed to a requester.

FIG. 11 is an exemplary computing system that can be used to practice exemplary recommendation request implementations described herein.

### DETAILED DESCRIPTION

In the following description of recommendation request implementations, reference is made to the accompanying drawings, which form a part thereof, and which show by way of illustration examples by which implementations described herein may be practiced. It is to be understood that other embodiments may be utilized and structural changes may be made without departing from the scope of the claimed subject matter.

### 1.0 Recommendation Request Implementations

The following sections provide an introduction and overview of the recommendation request implementations described herein, as well as exemplary processes and a system for practicing these implementations. Descriptions of exemplary user interfaces (Us) are also provided.

As a preliminary matter, some of the figures that follow describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

In general, the recommendation request implementations described herein request recommendations from a user's contacts or other people. In some implementations this is done by using a two part asynchronous search. In the first part of the search, objective criteria are defined by a first user to limit search results relating to the desired recommendation. In the second part of the search, a second user conducts a search for entities to recommend using an unstructured query. The search results are then ranked by their relevance to the unstructured query submitted by the second user and the objective criteria entered by the first user.

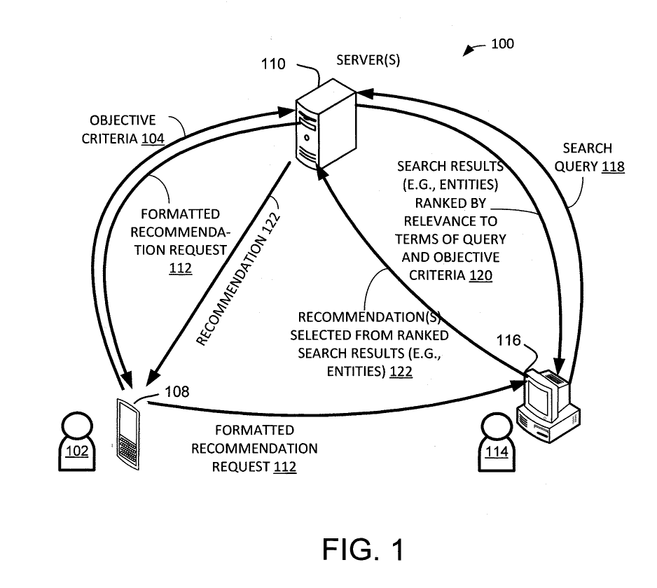

In one implementation 100, shown in FIG. 1, objective criteria are defined. For example, a first user 102 defines objective criteria 104 for a recommendation he desires on his computing device 108, such as, for example a mobile phone or a tablet computer. The objective criteria 104 can be based on selecting the objective criteria from pre-defined categories and sub-categories related to entities to recommend, or the objective criteria can be based on arbitrary terms or categories of entities the first user thinks of. In some implementations, the objective criteria 104 can be based on the context of the type of recommendation desired (e.g., if it is a book only books will be searched for, if it is a service, only services will be searched for). The objective criteria 104 can include the identification of the user that is looking for a recommendation, what type of recommendation they are looking for (e.g., a book, a restaurant, a plumber, a hardware store, a movie, a historical figure, or any other type of service provider, business, or object), comments provided by the user regarding the recommendation they are looking for, and possibly the user's location and in which geographic area or location the user is looking. In some implementations the objective criteria 104 can be based on previous searches done by the first user 102 that failed to yield a suitable recommendation. The objective criteria 104 can be sent from the first user's computing device 108 to one or more servers 110 (e.g., other computing devices or a computing cloud).

The server(s) 110 provide(s) a recommendation request 112 based on the objective criteria 104 that is formatted in a unique format that provides a location to enter a search query (for example, directly in the recommendation request itself or via a link (e.g., a URL) to a website that has a location to enter a search query). The user 102 that is desiring the recommendation (e.g., the requester) then shares the recommendation request with one or more other users (e.g., recipients) such as, for example, his on-line contacts, via one or more communication channels (e.g., social media, SMS, email, Quick Response (QR) code, etc.).

One or more recipients 114 of the request then use their computing device(s) 116 to each act on the recommendation request 112 they receive (for example, by selecting the URL in an email received from the first user/requester, on their social media page, in a text message, and so forth) and are presented an overview of the terms of the recommendation request and a location (e.g., a search bar) in which to enter a query in order to search for an entity to recommend. The query can be an unstructured query that has a number of terms that can be used to search for an entity in a database or other data repository. One or more recipients 114 then can enter a query 118 of search terms that come to mind and receive search results 120 of possible entities to recommend in response from an entity database (e.g., residing on the server(s) 110). In some implementations, the search for entities in the entity database can be limited to only those that meet the objective criteria.

The search results 120 (entities from the entity database) are ranked based on their relevance to the terms of the query, but also based on the objective criteria 104 associated with the recommendation request 112. For example, this can be done by ranking the search results 120 based on the terms of the search query 118 and then re-ranking these ranked search results based on the objective criteria 104. Alternately, the search terms of the query 118 can be combined with the objective criteria 104 in order to search for entities to recommend and determine the ranking. The one or more recipients 114 can then select one or more search results 120 and provide them as a recommendation 122. These recommendations 122 can then be retrieved by the first user/requester 102 (or the recommendations 122 can be sent directly to the first user/requester 102). In some implementations, the recipients can be presented with a pre-defined list of entities to recommend that are ranked based on the objective criteria and can select one or more of these with or without conducting a search for entities to recommend.

The recommendation request implementations described herein are advantageous in that they are capable of providing recommendations from familiar and trusted contacts that are pinpointed based on the objective criteria the requesting user desires. Furthermore, many recommendation requests can be performed in a short period of time, especially since the requests can be broadcast over a network to many contacts at the same time so that searches for suitable recommendations can be done in parallel by many people. This reduces the amount of time required to find a recommendation since many recipients can enter different query terms. This also provides a broader search for recommendations based on each recipient's thought process and experiences. Furthermore, a requester of a recommendation using a mobile device does not have to deal with numerous search results displayed on a small screen.

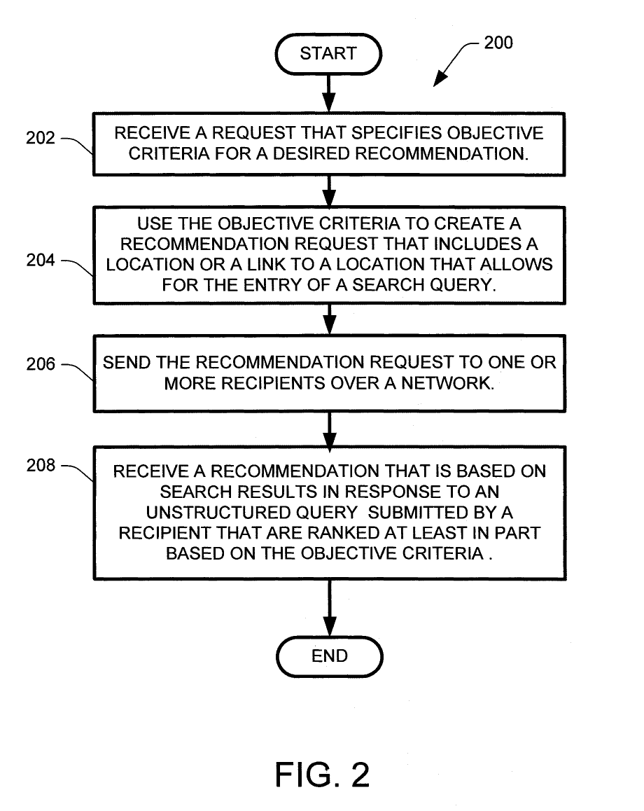

FIG. 2 depicts an exemplary process 200 for requesting recommendations from one or more contacts of a user. As shown in block 202, objective criteria for a desired recommendation are defined (e.g., by a requester). The objective criteria can be used to limit a search for a recommendation and are used to create a recommendation request that includes a location, or a link to a location, to enter a search query to search an entity database to find an entity to recommend, as shown in block 204. The recommendation request is sent to one or more recipients over a network, as shown in block 206. A recommendation that is based on search results received in response to an unstructured query submitted by the recipient that are ranked at least in part based on the objective criteria for the recommendation is received from at least one recipient, as shown in block 208.

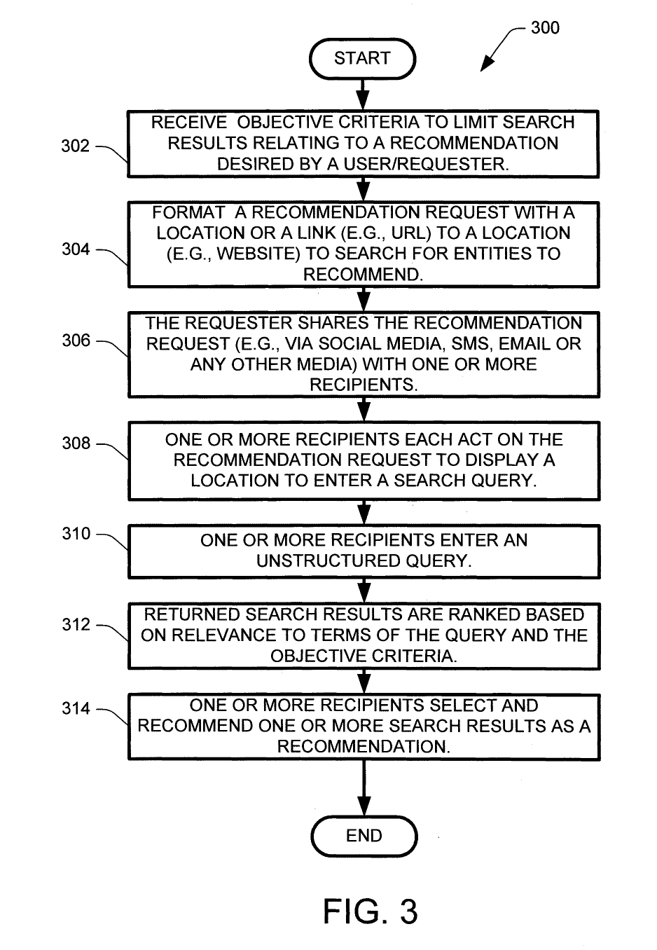

FIG. 3 depicts another exemplary process 300 for requesting a recommendation. As shown in block 302, objective criteria are defined to limit search results relating to the recommendation desired by a user/requester. The objective criteria can be based on selecting the objective criteria from pre-defined categories and sub-categories related to entities to recommend, or the objective criteria can be based on arbitrary terms or categories of entities the user thinks of. In some implementations, the objective criteria can be based on the context of the type of recommendation desired (e.g., if the recommendation desired is for a book only books will be searched for, if the recommendation desired is for a service, only services will be searched for). The objective criteria may comprise the name or other identification of the user/requester that is looking for a recommendation, what type of recommendation they are looking for (e.g., a book, a restaurant, a plumber, a hardware store, a type of plant, a movie, a historical figure, or any other type of service provider, business, object or service), any comments the user might input, and in some cases the geographic location of the user and in which geographic area or location they are looking in. These objective criteria are then uniquely specified in a recommendation request which contains a location in which to enter a search query or a link to a location in which to enter a search query (e.g., a URL to a website), as shown in block 304. The requester then uses his computing device to share the formatted recommendation request with other users or on-line contacts (for example, contacts that are known to him), via one or more communications channels (e.g., social media, SMS, email, QR code, etc.), as shown in block 306. The recipients of the request then act on the received message by opening it or by acting on the link/URL in the recommendation request (for example, by selecting it with an input device in an email received from the requester, on their social media page, in a text message, and so forth) in which case the recipient is provided with a summary of the terms of the recommendation request and a location to search for an entity that fulfills the request using a search engine, as shown in block 308. Each recipient can then conduct a search by entering a query on their computing device to search an entity database for one or more entities to fulfill the request, as shown in block 310. This entered query can be an unstructured query that comprises the search terms that come to mind to the recipient when responding to the recommendation request. Search results are then returned in response to the query and these search results are ranked not only based on the search terms of the query entered by the recipient, but also the objective criteria defined by the requester (block 312). Each recipient can then select and recommend one or more of the search results (e.g., entities) as a recommendation in response to the recommendation request, as shown in block 314.

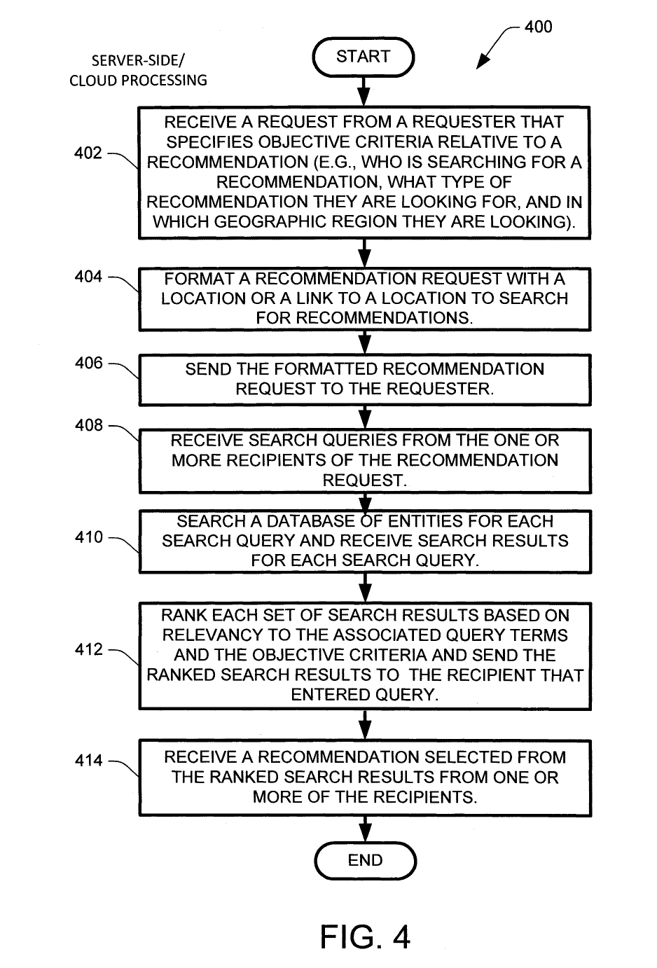

FIG. 4 depicts another exemplary process 400 for generating a request for a recommendation. Such process 400 might be implemented on a server or a computing cloud. As shown in block 402, a request is received at the server/computing cloud that specifies objective criteria (e.g., who is searching for a recommendation, what type of recommendation they are looking for, any comments they made, and possibly the geographic location of the user and in which geographic region they are looking, among other criteria). In some embodiments the objective criteria can be provided to the user/requester organized by pre-defined categories and subcategories (e.g., a category of service provider and a sub-category of plumber, or a category of book and a sub-category of mystery, or a category of toy and a sub-category of doll). The objective criteria are then formatted as a recommendation request that includes a location to search for an entity to fulfill the request or that provides a link (for example a URL) to a location, such as a website, where the recipient can conduct a search, as shown in block 404. The recommendation request can be formatted to include the identification of the user that originated the request, the objective criteria, the location of the user and any comments the user defined regarding the parameters of the request. In some implementations, when a recommendation request is created, the request is assigned a unique identifier and is stored in a recommendation request database. Recommendations returned in response to that request are then associated with the request via the unique identifier. In some implementations, when a user requests a recommendation a webpage or a page on an application is created and associated with the request via the unique identifier.

Once the recommendation request is created, the recommendation request is then sent back to the requester and can be shared with one or more recipients (e.g., contacts of the requestor that is making the request) over a network, as shown in block 406. Queries (e.g., unstructured queries) are then received from one or more of the recipients that received the request (as shown in block 408). A search of a database of entities is conducted for each received query (block 410). For each received query, the search results are ranked using the terms of the received query as well as the objective criteria. The search results (e.g., entities) of each request are provided to the contact/recipient that entered the search query (as shown in block 412). A selection of a search result as a recommendation is received from one or more of the recipients, as shown in block 414. It is also possible for the recipient to recommend more than one of the search results as a recommendation. The recommendation(s) can be posted to a location (e.g., a website) or can be otherwise provided to the requester.

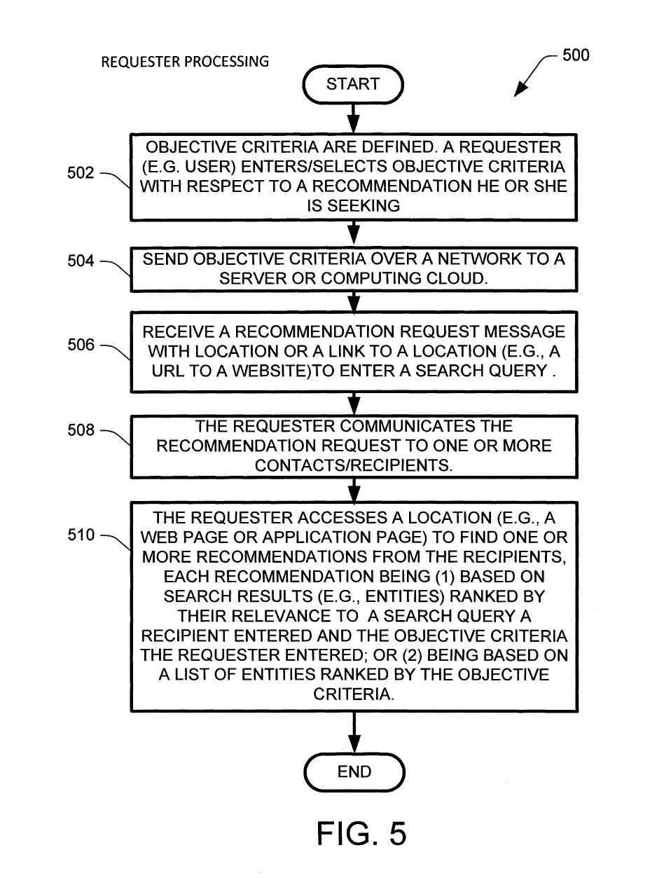

FIG. 5 depicts another exemplary process 500 for generating a request for a recommendation and receiving such a recommendation. Such process 500 might be implemented on the computing device of a user (e.g., requester) that is seeking a recommendation. As shown in block 502, objective criteria are defined. For example, a requester (e.g., user) enters or selects objective criteria with respect to a recommendation he or she is seeking (e.g., who is searching for a recommendation, what type of recommendation they are looking for, their location, and possibly in which geographic region they are looking, among others) and sends this over a network to a server or computing cloud, as shown in 504. The requester then receives a recommendation request message (block 506). This message can include a location in which to enter a search query or can include a link to a website that includes a location where the recipient can enter a search query to search for an entity that fulfills the recommendation request. The requester indicates that he or she would like to share the request and the computing device then shares the formatted recommendation request message with one or more recipients or contacts of the requester (block 508). As shown in block 510, the requester then accesses a web page or other location to find one or more recommendations from the recipient(s), each recommendation being based on search results ranked by their relevance to a search query a recipient entered in order to find a recommendation and the objective criteria the requester entered.

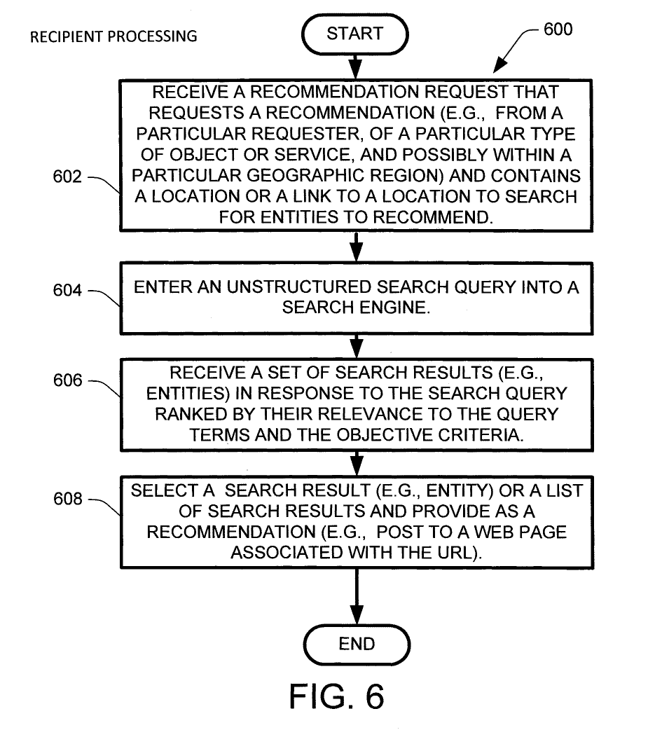

FIG. 6 depicts another exemplary process 600 for generating a recommendation. Such process 600 might be implemented on a computing device of a contact or recipient that received a request for a recommendation. As shown in block 602, a recommendation request is received that specifies objective criteria (e.g., who is searching for a recommendation, what type of recommendation they are looking for, their geographic location, comments regarding the recommendation, and possibly in which geographic region they are looking, among others). The recommendation request includes a location or a link to a location where the recipient can enter a search query to find entities to recommend to the requestor. The recipient enters a search query into the location where the query can be entered and a search is conducted by a search engine using the terms of the search query entered by the recipient, as shown in block 604. Search results (e.g., entities) are returned that are ranked by their relevance to the terms of the search query and the objective criteria specified in the request (block 606). The recipient then selects a search result (e.g., entity) which then limits the list of search results further. The recipient's computer communicates the limited list as recommendations to the requester (where the first user can view the limited list), as shown in block 508. In other implementations just a single recommendation is transmitted from the first user, and the computer of the first user may combine the terms of the recommendation and the objective criteria in order to query an entity database. In some implementations, the recommendation may be selected from a list of entities that are ranked based on the objective criteria, with or without the recipient entering a query.

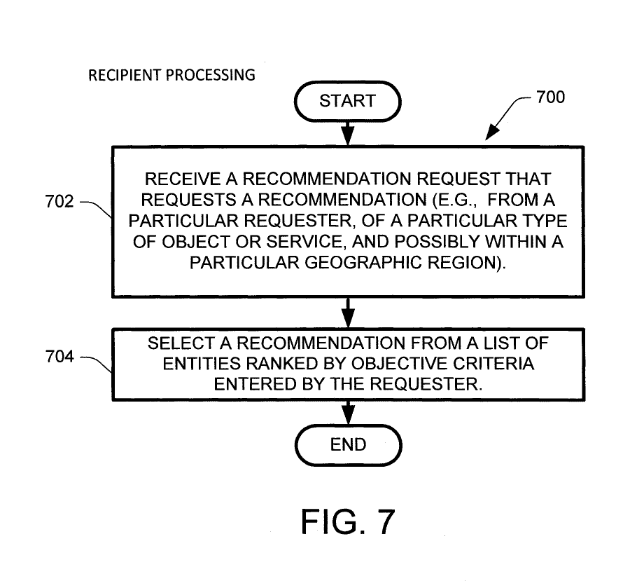

FIG. 7 depicts another exemplary process 700 for generating a recommendation. Such process 700 might be implemented on a computing device of a contact or recipient that received a request for a recommendation. As shown in block 702, a recommendation request is received that specifies objective criteria (e.g., who is searching for a recommendation, what type of recommendation they are looking for, their geographic location, comments regarding the recommendation, and possibly in which geographic region they are looking, among others). The recommendation request includes a list of entities to recommend, ranked by their relevance to the objective criteria. The recipient then selects an entity from the list and provides it as a recommendation in response to the request, as shown in block 704.

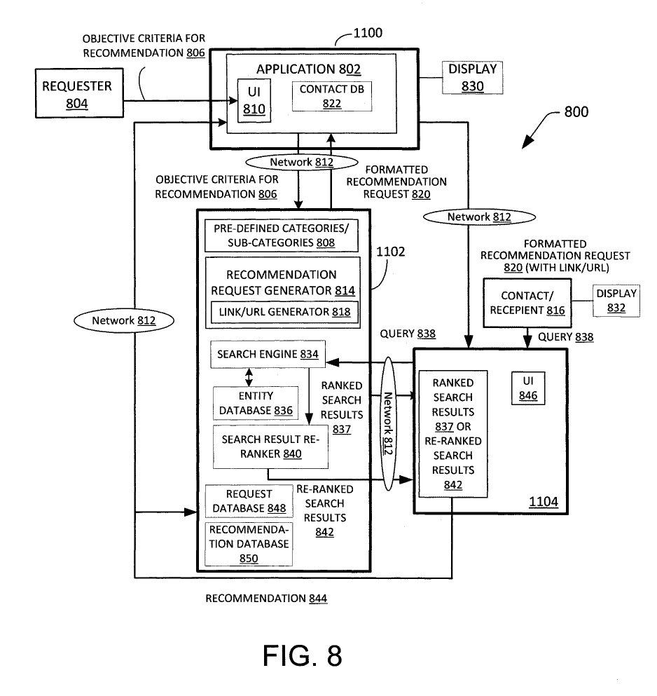

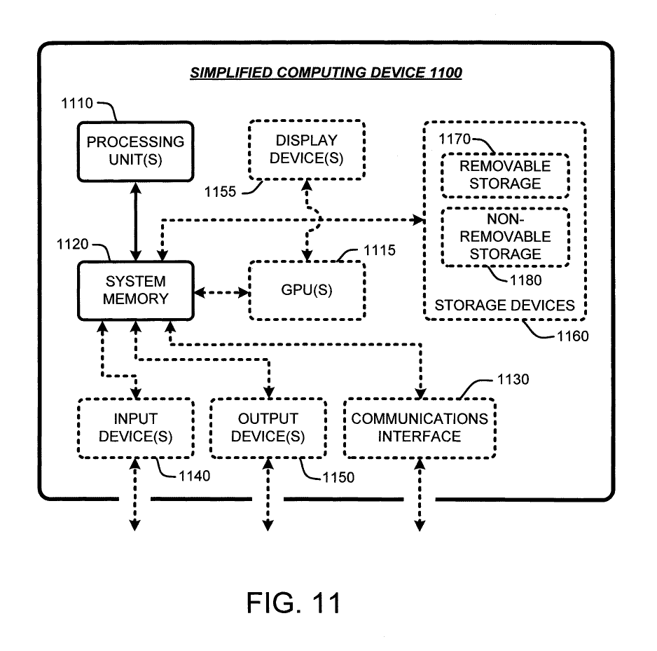

FIG. 8 depicts an exemplary system 800 for practicing various recommendation request implementations as described herein. A recommendation application 802 is located on a computing device 1100 of a requester 804. The computing device 1100 can be one such as will be described in greater detail with respect to FIG. 11. The requester 804 is a user that can define objective criteria 806 for a desired recommendation. The objective criteria 806 can be, for example, the type of service or service provider the requester is looking for, comments made by the requester, the location of the requester, the geographic location of the service/service provider and the name of the requester, among others. In some implementations the objective criteria can be derived from terms the requester enters into a search engine. In some implementations the objective criteria can be categorized by pre-defined categories 808 (e.g., service provider, book, and movie). In some implementations, the requester can formulate the objective criteria by selecting categories and sub-categories from menus on a displayed user interface. The requester 804 can enter the objective criteria 806 into the computing device 1100 via the user interface 810.

The objective criteria are sent over a network 812 to another computing device 1102 on which resides a recommendation request generator 814 which formats the objective criteria 806 received from the requester 804 into a recommendation request 820 message format that can be sent to one or more recipients 816. The recommendation request 820 is stored in a recommendation request database 848 where it is identified with a unique identifier. Recommendations returned in response to the request can be also be stored in the recommendation request database 848 or can be stored in a recommendation database 850 that is linked to the recommendation request database 848. The recipients 816 of the recommendation request do not have to use the application 802 that the requester 804 is using or be logged into any other service or application in common with the requester. In some implementations the recommendation request generator 814 formats the recommendation request to include a location such as a search box in which the recipient can enter a search query. In some implementations, the recommendation request generator 814 formats the recommendation request 820 into a format that includes a link such as a Uniform Resources Locator (URL) via a URL generator 818 to a webpage or an application page that includes a location in which the recipient of the request can enter a search query to search an entity database for an entity to recommend in response to the request. In some implementations, the recommendation request generator ranks a list of entities obtained from the entity database that might fulfill the recommendation request by the objective criteria and prompts a user to select an entity from the list (with or without the recipient entering a search query).

The formatted recommendation request 820 is sent over the network 812 to the application 802. The requester 804 provides the formatted recommendation request 820 to a contact or other recipient 816 that he or she wishes to receive a recommendation from. The contact or recipient 816 can be a contact that is in the requester's 804 contact database 822. The requester 804 can provide the formatted request in many ways, such as, for example, via email to the recipient over a network, via SMS (Short Message Service) or text message, by posting the formatted request to the recipient's social network page, or via any other means.

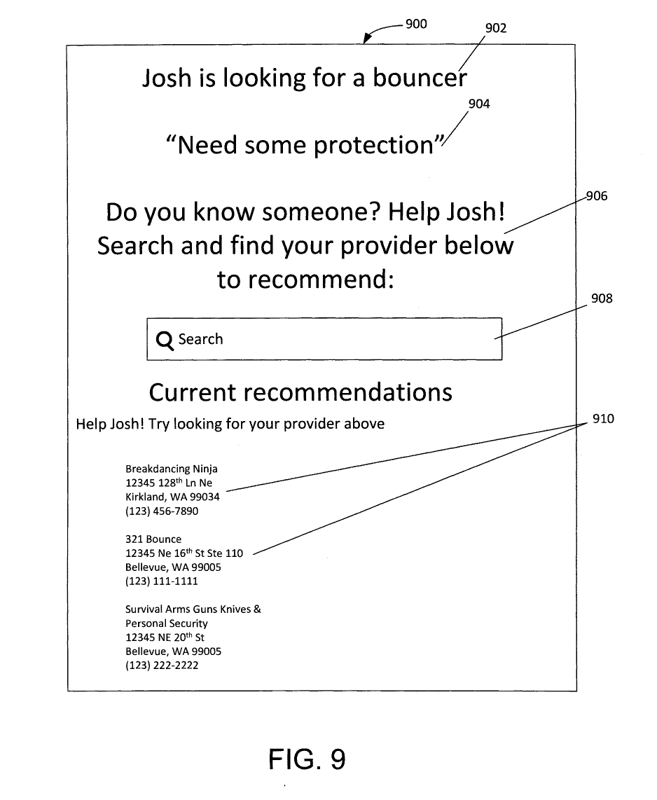

FIG. 9 provides an exemplary formatted recommendation request 900 that is displayed on the display 832 of the recipient's computing device 1104 and manipulated by the recipient 816 via an associated user interface 846. As shown in FIG. 9, the formatted request 900 includes information 902 as to what the requester is requesting (e.g., “Josh is looking for a bouncer”). The formatted request 900 can also display comments 904 provided by the user. The formatted request 900 also displays instructions 906 to prompt the recipient to enter a search query of search terms that the user thinks would be useful in finding the requested recommendation via a search box 908. The recipient can enter any unstructured query into the search box 908 that comes to mind. Query terms that come to mind may be based on the recipient's knowledge and experiences, so the queries entered may vary from recipient to recipient for the same recommendation request. In some implementations, as discussed above, the recommendation request can include a list of entities selected based on the objective criteria from which the recipient of the recommendation request can select.

When the requester enters the query comprising various search terms into the search box 908, these terms are submitted to a search engine 834 that searches an entity database 836 for entities to recommend. For example, the entity database 836 can include a list of entities each being associated with a category and sub-category, a number of keywords that will return the associated entity in response to a search query, along with other relevant information about the entity (e.g., the address of a service provider, the types of goods a store sells, the types of foods a restaurant serves, a book genre, and so forth). The terms of the entered query can be matched to the keywords associated with one or more entities. In one recommendation request implementation, the terms of the query and the terms of the objective criteria are combined and are used by the search engine 834 to rank the entities via a standard ranking algorithm and send them to the recipient 812. In one implementation the relevance of the returned search results (e.g., entities) to terms of the query 838 are determined and the results are ranked. These ranked search results 837 are sent to a search result re-ranker 840. The search result re-ranker 840 re-ranks the received search results 837 based on the objective criteria 806 to obtain re-ranked search results 842 that are sent back and displayed on the display 820 of the recipient 816. The recipient then selects one of the ranked search results 837 (if they are initially ranked both on objective criteria and relevance to the query) or the re-ranked search results 840 as a recommendation 844 and provides this recommendation back to the requester 804. In some implementations this is done by posting the recommendation 844 to a web page or other location associated with the original recommendation request. The recommendation 844 is saved to the recommendation request database 848 or the recommendation database 850 as appropriate.

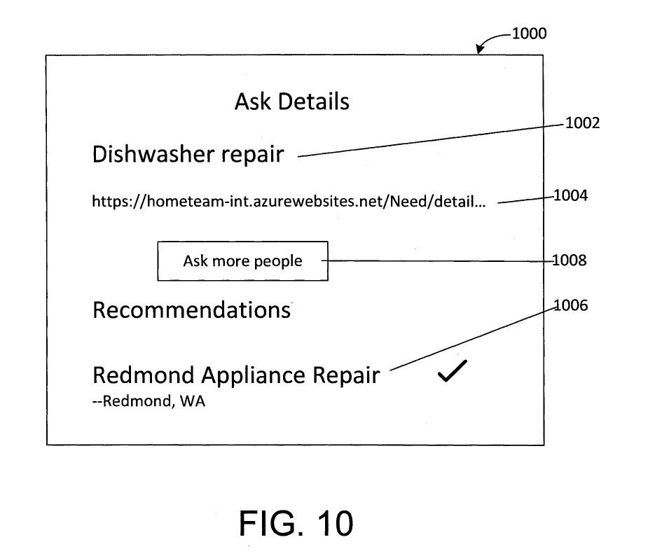

FIG. 10 provides an exemplary formatted recommendation page 1000 that is displayed on the display 830 of the requestor's computing device 1104. As shown in FIG. 10, the formatted recommendation page 1000 includes a line that briefly describes the type of request 1002, the link or URL 1004, and the recommendation(s) 1006. The formatted recommendation request page 1000 also includes a button 1008 which the requester can select in order to send the formatted request to additional recipients (e.g., after the first recommendation is received). Alternately, or in addition, the requester can copy the URL/link and paste it into an email, post it on a recipient's social media page or provide it to a recipient in another manner. Recommendations 1006 from numerous recipients can be displayed on the recommendation page.

### 2.0 Other Implementations

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of detailed description of the recommendation request implementation described above.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

The following paragraphs summarize various examples of implementations which may be claimed in the present document. However, it should be understood that the implementations summarized below are not intended to limit the subject matter which may be claimed in view of the foregoing descriptions. Further, any or all of the implementations summarized below may be claimed in any desired combination with some or all of the implementations described throughout the foregoing description and any implementations illustrated in one or more of the figures, and any other implementations described below. In addition, it should be noted that the following implementations are intended to be understood in view of the foregoing description and figures described throughout this document.

Various recommendation request implementations are by means, systems processes or techniques for requesting recommendations and receiving recommendations from one or more recipients of a recommendation request. As such some recommendation request implementations described herein have been observed to improve the speed, efficiency and accuracy of obtaining a recommendation over a computer network.

As a first example, in various implementations, a process for requesting a recommendation is provided via means, processes or techniques for receiving from a requester objective criteria for a desired recommendation, and providing a recommendation request to one or more recipients over a network. A recommendation is received that is based on search results returned in response to a query submitted by at least one recipient where the search results are ranked based on the terms of the query and at least in part based on the objective criteria.

As a second example, in various implementations, the first example is further modified via means, processes or techniques such that the objective criteria comprise a class of entity for which the recommendation is sought.

As a third example, in various implementations, the second example is further modified via means, processes or techniques such that the class of entity for which a recommendation is sought is selected from a group of pre-defined entity classes.

As a fourth example, in various implementations, the second example, and the third example are further modified via means, processes or techniques such that the pre-defined entity classes comprise at least one of a group comprising a service provider, a product or an object.

As a fifth example, in various implementations, the first example, the second example, the third example and the fourth example are further modified via means, processes or techniques such that the search results to the query submitted by the recipient are ranked based on relevance to terms of the unstructured query and the objective criteria.

As a sixth example, in various implementations, the first example, the second example, the third example, the fourth example and the fifth example are further modified via means, processes or techniques such that the recommendation request comprises a link to a webpage.

As a seventh example, in various implementations, the sixth example is further modified via means, processes or techniques such that the link is copied and pasted in order to request a recommendation from a recipient.

As an eighth example, in various implementations, the first example, the second example, the third example, the fourth example, the fifth example, the sixth example and the seventh example are further modified via means, processes or techniques such that the recommendation request comprises a location to enter a search query.

As a ninth example, in various implementations, the first example, the second example, the third example, the fourth example, the fifth example, the sixth example, the seventh example and the eighth example are further modified via means, processes or techniques such that the recommendation request is provided to additional recipients after receiving a recommendation.

As a tenth example, in various implementations, the first example, the second example, the third example, the fourth example, the fifth example, the sixth example, the seventh example, the eighth example and the ninth example are further modified via means, processes and techniques such that the recommendation request is provided to one or more recipients by emailing the request, posting the request to a social network page, or sending the request by a text message.

As a eleventh example, in various implementations, the first example, the second example, the third example, the fourth example, the fifth example, the sixth example, the seventh example, the eighth example, the ninth example, and the tenth example are further modified via means, processes and techniques such that a list of entities to recommend are provided to a recipient.

As a twelfth example, in various implementations, a process for requesting a recommendation is provided via means, processes or techniques for receiving a recommendation request; entering an unstructured query into a search engine to search a database of entities to find an entity to fulfill the recommendation request; ranking search results received in response to the query by relevance to the terms of the unstructured query and to objective criteria associated with the recommendation request; and receiving a selection of a ranked search result from a user as a recommendation.

As a thirteenth example, in various implementations, the twelfth example is further modified via means, processes or techniques such that the recommendation is provided to the user that generated the recommendation request.

As a fourteenth example, in various implementations, the twelfth example and the thirteenth example are further modified such that the received recommendation request comprises at least part of the objective criteria used to rank the search results.

As a fifteenth example, in various implementations, the twelfth example, the thirteenth example and the fourteenth example are further modified such that the recommendation request comprises a link to a website that allows entry of the unstructured query into a search engine and displays the ranked search results.

As a sixteenth example, in various implementations, a system is provided via means, processes or techniques for requesting a recommendation. The system can include one or more computing devices each having a processor and a memory, wherein the computing devices are in communication with each other via a computer network whenever there are multiple computing devices, and a computer program having program modules executed by the one or more of the computing devices. The computer program can direct the program modules of the computer program to: receive objective criteria to limit search results relating to a recommendation; format a recommendation request with a location or a link to a location to search for entities to recommend; share the recommendation request with one or more recipients; receive from the one or more recipients, acting on the recommendation request, an unstructured search query to search for one or more entities; rank search results in response to each search query based on relevance to terms of an associated search query and the objective criteria; and receive from the one or more recipients a selection of one or more ranked search results as a recommendation.

As a seventeenth example, in various implementations, the sixteenth example, is further modified via means, processes or techniques such that a search engine returns search results in the form of entities.

As an eighteenth example, in various implementations, the sixteenth example and the seventeenth example are further modified via means, processes or techniques such that the objective criteria is received from a requester and used to generate the recommendation request.

As a nineteenth example, in various implementations, the sixteenth example, the seventeenth example, and the eighteenth example are further modified via means, processes or techniques to include a user interface that allows a requester to enter objective criteria relative to a recommendation being sought and displays the provided recommendation.

As a twentieth example, in various implementations, the sixteenth example, the seventeenth example, the eighteenth example and the nineteenth example are further modified via means, processes or techniques to include a user interface that displays the recommendation request to a recipient and provides a location where the recipient can enter the query and select a returned result as a recommendation that is provided to the requester.

### 3.0 Exemplary Operating Environment:

The recommendation request implementations described herein are operational within numerous types of general purpose or special purpose computing system environments or configurations. FIG. 11 illustrates a simplified example of a general-purpose computer system on which various elements of the recommendation request implementations, as described herein, may be implemented. For example, the computing device 1100 can be used as the computing devices 108, 110 and 116 shown in FIG. 1. It is noted that any boxes that are represented by broken or dashed lines in the simplified computing device 1100 shown in FIG. 11 represent alternate implementations of the simplified computing device. As described below, any or all of these alternate implementations may be used in combination with other alternate implementations that are described throughout this document.

The simplified computing device 1100 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device, such as, for example, the computing devices 108, 110 and 116 shown in FIG. 1, to realize the recommendation request implementations described herein, the device should have a sufficient computational capability and system memory to enable basic computational operations. In particular, the computational capability of the simplified computing device 1100 shown in FIG. 1100 is generally illustrated by one or more processing unit(s) 1110, and may also include one or more graphics processing units (GPUs) 1115, either or both in communication with system memory 1120. Note that that the processing unit(s) 1110 of the simplified computing device 1100 may be specialized microprocessors (such as a digital signal processor (DSP), a very long instruction word (VLIW) processor, a field-programmable gate array (FPGA), or other micro-controller) or can be conventional central processing units (CPUs) having one or more processing cores and that may also include one or more GPU-based cores or other specific-purpose cores in a multi-core processor.

In addition, the simplified computing device 1100, which can be used as the computing device 108, 110 or 116 shown in FIG. 1, may also include other components, such as, for example, a communications interface 1130. The simplified computing device 1100 may also include one or more conventional computer input devices 1140 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 1100, which can be used as the computing devices 108, 110 or 116 shown in FIG. 1, and with any other component or feature of the recommendation request implementations, including input, output, control, feedback, and response to one or more users or other devices or systems associated with the recommendation request implementations, are enabled by a variety of Natural User Interface (NUI) scenarios. The NUI techniques and scenarios enabled by the recommendation request implementations include, but are not limited to, interface technologies that allow one or more users user to interact with the recommendation request implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other input devices 1140 or system sensors 1105. Such NUI implementations are also enabled by the use of various techniques including, but not limited to, information derived from system sensors 1105 or other input devices 1140 from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited to, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the recommendation request implementations.

However, it should be understood that the aforementioned exemplary NUI scenarios may be further augmented by combining the use of artificial constraints or additional signals with any combination of NUI inputs. Such artificial constraints or additional signals may be imposed or generated by input devices 1140 such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the recommendation request implementations.

The simplified computing device 1100, which can be used as the computing devices 108, 110 or 116 shown in FIG. 1, may also include other optional components such as one or more conventional computer output devices 1150 (e.g., display device(s) 1155, audio output devices, video output devices, devices for transmitting wired or wireless data transmissions, and the like). Note that typical communications interfaces 1130, input devices 1140, output devices 1150, and storage devices 1160 for general-purpose computers are well known to those skilled in the art, and will not be described in detail herein.

The simplified computing device 1100 shown in FIG. 11 may also include a variety of computer-readable media. Computer-readable media can be any available media that can be accessed by the computing device 1100 via storage devices 1160, and include both volatile and nonvolatile media that is either removable 1170 and/or non-removable 1180, for storage of information such as computer-readable or computer-executable instructions, data structures, program modules, or other data.

Computer-readable media includes computer storage media and communication media. Computer storage media refers to tangible computer-readable or machine-readable media or storage devices such as digital versatile disks (DVDs), Blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various recommendation request implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware 1125, hardware, or any combination thereof to control a computer to implement the disclosed subject matter. The term “article of manufacture” as used herein is intended to encompass a computer program accessible from any computer-readable device, or media.

The recommendation request implementations described herein may be further described in the general context of computer-executable instructions, such as program modules, being executed by a computing device. Generally, program modules include routines, programs, objects, components, data structures, and the like, that perform particular tasks or implement particular abstract data types. The recommendation request implementations may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

The foregoing description of the recommendation request implementations have been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate implementations may be used in any combination desired to form additional hybrid implementations of the recommendation request implementation. It is intended that the scope of the invention be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What is claimed is:

1. A system, comprising:
one or more computing devices each comprising a processor, communication interface and memory, wherein said computing devices are in communication with each other via a computer network whenever there are multiple computing devices; and
a computer program having program modules executable by the one or more computing devices, the one or more computing devices being directed by the program modules of the computer program to,
receive objective criteria to limit search results relating to a recommendation;
format a recommendation request with a location or link to a location to search for entities to recommend;
share the recommendation request with one or more recipients;
receive from the one or more recipients, acting on a received recommendation request, an unstructured search query to search for one or more entities;
rank search results returned in response to each search query based on relevance to terms of an associated query and the objective criteria; and
receive from one or more of the recipients a selection of one or more ranked search results as a recommendation.

2. The system of claim 1 wherein the search results are in the form of entities.

3. The system of claim 1 wherein the objective criteria is received from a requester and used to generate the recommendation request.

4. The system of claim 3, further comprising a user interface that allows the requester to enter the objective criteria relative to a recommendation being sought and displays the provided recommendation.

5. The system of claim 1, further comprising a user interface that displays the recommendation request to a recipient and provides a location where the recipient can enter the query and select a returned result as a recommendation that is provided to the requester.

6. A computer-implemented process for requesting a recommendation, comprising using a computing device for:
receiving objective criteria for a desired recommendation;
providing a recommendation request to one or more recipients over a network;
receiving from at least one recipient a recommendation that is based on search results returned in response to an unstructured query submitted by the recipient that are ranked based on terms of the query and at least in part based on the objective criteria for the desired recommendation.

7. The computer-implemented process of claim 6 wherein the objective criteria comprises a class of entity for which the recommendation is sought.

8. The computer-implemented process of claim 7 wherein the class of entity for which a recommendation is sought is selected from a group of pre-defined entity classes.

9. The computer-implemented process of claim 8 wherein the pre-defined entity classes comprise at least one of a group comprising:
a service provider; or
a product; or
an object.

10. The computer-implemented process of claim 6 wherein the search results to the query submitted by the recipient are ranked based on relevance to terms of the unstructured query and the objective criteria.

11. The computer-implemented process of claim 6 wherein the recommendation request comprises a link to a web page.

12. The computer-implemented process of claim 11, further comprising copying and pasting the link in order to request a recommendation from a recipient.

13. The computer-implemented process of claim 6, wherein the recommendation request further comprises a location to enter a search query.

14. The computer-implemented process of claim 6, further comprising:
providing the recommendation request to additional recipients after receiving a recommendation.

15. The computer-implemented process of claim 6, wherein the recommendation request is provided to the one or more recipients by at least one of the following:
emailing the request; or
posting the request to a social network page; or
sending the request by a text message.

16. The computer-implemented process of claim 6, wherein a list of entities to recommend is provided to a recipient and wherein the recipient selects an entity as a recommendation.

17. A computer-implemented process for providing a recommendation, comprising:
receiving a recommendation request;
receiving an unstructured query to search a database of entities to find an entity to fulfill the recommendation request;
receiving ranked search results in response to the query, wherein the search results are ranked by relevance to the terms of the unstructured query and to objective criteria associated with the recommendation request; and
receiving a selection of one or more ranked search results from a user as a recommendation.

18. The computer-implemented process of claim 17, further comprising;
providing the recommendation to a requester that generated the recommendation request.

19. The computer-implemented process of claim 17, wherein the received recommendation request comprises at least part of the objective criteria used to rank the search results.

20. The computer-implemented process of claim 17, wherein the recommendation request comprises a link to a website that allows entry of the unstructured query into a search engine and displays the ranked search results.
